(19) United States
(12) Patent Application Publication
(10) Pub. No.: US 2004/0258876 A1
(43) Pub. Date: Dec. 23, 2004

(54) Towel

(76) Inventor: David Leslie, Phoenix, AZ (US)

Correspondence Address: Marvin H. Kleinberg, Kleinberg & Lerner, LLP, Suite 1080, 2049 Century Park East, Los Angeles, CA, 90067, US

(21) Appl. No.: 10/725,135

(22) Filed: Dec. 1, 2003

Related U.S. Application Data
(63) Continuation-in-part of application No. 09/829,579, filed on Apr. 10, 2001, now Pat. No. 6,655,387.

(51) Int. Cl. B32B 3/06

(52) U.S. Cl. 428/99; 428/100; 428/136

(57) ABSTRACT

An improved towel with a top edge, first and second side edges and a bottom edge, is provided with a slit into the towel, the slit extending partially into the towel from one of the side edges and is disposed substantially parallel to the top and bottom edges. Reinforcement means include bias tape or piping on the slit edges and may be continuous. Attachment means may be provided at the two corners of the towel adjacent the slit.

This is a continuation-in-part of application Ser. No. 09/829,579, filed Apr. 10, 2001.

### BACKGROUND OF THE INVENTION

1. Field of the Invention

The present invention relates to the field of towels, and more particularly to an improved towel that is intended to be used in a hair salon or within the hair care, cosmetology, spa and other related industries and services.

2. Prior Art

The present invention is primarily intended to be used within the cosmetology, beauty and hair care industries. Whenever a client visits a hair salon for a haircut or other related salon services, it is customary to for the salon to provide a towel which covers the person's neck and shoulders. The purpose of the towel is to provide protection to the client's clothing and skin from any hair clippings, water or chemicals which may be used. This protection is increasingly more important, given the ever more prevalent use of special colorings, dyes and other materials in the beauty and hair care industry. Similarly, in the cosmetics and cosmetology fields it is often desired to provide a protective covering for the customer who is applying beauty products.

In the past, it has been the usual practice to use an ordinary, rectangular, towel to provide the client with the needed protection.

This approach has not been entirely satisfactory, however. A rectangular towel is not necessarily well suited to fit comfortably around a person's neck. The towel will not drape smoothly over the person's shoulders and will typically bunch up to form wrinkles and voids. The towel will not have a continuous fall from the shoulder. This is not desirable for a number of reasons. First, the presence of the wrinkles and voids results in an unkempt and unprofessional appearance. This is often unacceptable to the hair and beauty salon.

In addition, the voids and open spaces can allow the hair clippings, chemicals and other items to fall beneath the towel. In that case, the protection which the towel is sought to provide is obviated. Also, bunching around the neck limits the application of styling chemicals and other grooming techniques.

It has been known in the past to use special smocks or aprons which can take the place of the usual towel. These alternative items have their drawbacks and own limitations, however. The specialized smocks and aprons are often bigger and more cumbersome than a towel. Perhaps most important, these items are significantly more expensive to manufacture. This leads to higher prices for the salon. Being bigger, they are also more expensive to launder, and the laundry costs are usually paid for by the salon.

### SUMMARY OF THE PRESENT INVENTION

The present invention provides an improved towel which is intended and designed to overcome the limitations of the prior art. The towel is intended to be used primarily in the cosmetology, beauty and hair care industries. The present invention provides a towel which has at least a top edge and first and second side edges, and contains an improvement, which includes a slit cut into the towel, the slit extends partially into the towel from the side edge and is disposed substantially parallel to the top and bottom edges, the towel further includes a continuous piping or reinforcement means located on the towel substantially binding the entire slit or may be merely a reinforcement adjacent to an end point of the slit, and an attachment means coupled to two corners of the towel.

### BRIEF DESCRIPTION OF THE DRAWINGS

FIG. 1 is a top plan view of the preferred embodiment of the present invention.

FIG. 2 is a perspective view showing how the towel of the present invention is used.

FIG. 3 illustrates an alternative embodiment of the present invention.

### DETAILED DESCRIPTION OF THE PREFERRED EMBODIMENT

An improved towel will be described. In the following description, for the purposes of explanation, specific construction details, arrangements, and materials are set forth in order to provide a more thorough understanding of the present invention. It will be apparent to those skilled in the art, however, that the present invention may be practiced without these specific details. In other instances, well known manufacturing methods and structures have not been described in detail so as not to obscure the present invention unnecessarily.

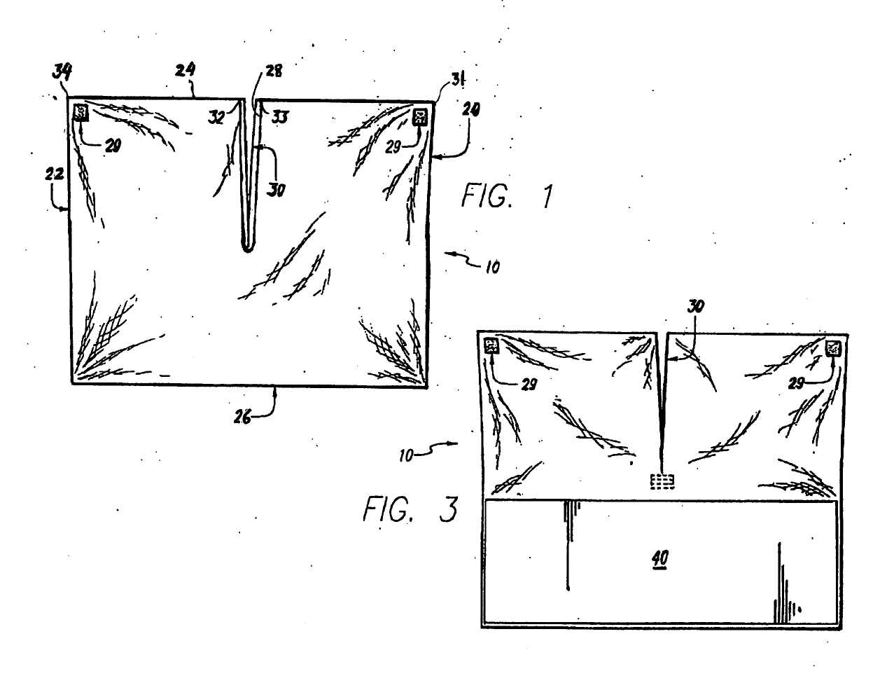

Referring first to FIG. 1, a top plan view of the preferred embodiment of the improved towel 10 is shown. The towel is approximately rectangular in shape. The towel of the present invention is generally of the size of towels which are used in the beauty and hair care industry. A common size for such towels is approximately 17 by 23 inches. It will be apparent to those skilled in the art, however, that the exact dimensions of the towel 10 may vary from these amounts without departing from the overall spirit and scope of the present invention.

The towel is manufactured from any suitable material. By way of example, the towel can be manufactured from cotton. Cotton is a common and widely accepted material for towels which are used within the hair care industry. Other fabrics or materials can also be used for the towel. These other fabrics include natural materials such as wool, or synthetics such as polyester or rayon. The towel is manufactured to have a sheet-like or web construction. An alternative embodiment of the towel is manufactured from paper. The paper may be coated or impregnated with a material to make it water resistant. It will be apparent to those skilled in the art that the exact material chosen will vary according to the design choice of the user, and the specific application in which the towel is used.

Referring again to FIG. 1, the towel 10 is seen to have a top edge 20, a bottom edge 22 and two side edges 24 and 26. A slit 30 is cut into the towel. The slit 30 extends downward from one of the side edges 24. It is disposed substantially parallel to the top and bottom edges 20 and 22. The slit 30 does not extend all of the way through the towel 10. It instead stops at a point that is part way through the towel. It has been found that in the preferred embodiment, the slit should extend approximately one-third to one-half of the distance between the side edges.

A continuous piping reinforcement 28 is placed on the towel over the raw edges of the slit 30. In the preferred embodiment, the piping 28 is made from a sturdy cloth material that is stitched in place. The reinforcement will prevent the towel from ripping or tearing, and keep the slit 30 from extending further than intended into the towel. Other means of reinforcing the towel can also be used with similar effectiveness.

The towel, being rectangular in shape, will normally have four corners. Referring again to FIG. 1, there is a first, upper corner 31 and a second, lower corner 34 on the bottom side 22 of the towel 10. The addition of the slit 30 creates two additional corners 32, 33.

The preferred embodiment of the towel 10 includes closure means 29 which are attached to the towel near corners 31 and 34. The closure means 29 allow the towel to be fixed around the neck and shoulders of a user, and its operation is described in more detail with respect to FIG. 2 below.

The exact structure of the closure means 29 may take a variety of forms. In the preferred embodiment, the closure means 29 comprise patches of hook and loop material. In alternative embodiments, a simple button and button hole may be used. It will be apparent to those skilled in the art, however, that the closure means may take many alternative embodiments. In other, alternative embodiments, the closure may be strings or laces that can be tied together. In yet another alternative embodiment, the closure may be a snap fastener.

It will also be apparent to those skilled in the art that the closure means may also be omitted from the towel, and that the towel can be placed loosely around the user's shoulders when in use, and not fixed in place.

The use of the towel is illustrated in FIG. 2. While the towel is in use, it is placed over the neck and shoulders of a person, so as to provide coverage and protection for their clothing and skin. The towel is grasped by top and bottom corners 31, 34, best seen in FIG. 1. This allows corners 32 and 33, which are adjacent to slit 30 to fall downward.

This results in a substantially V-shaped opening in the upper portion of the towel (not shown in FIG. 2.) The corners 31 and 34 are then wrapped around the user's shoulders. The corners may then be fastened together by using the closure means described in FIG. 1 above.

The presence of the V-shaped opening allows the towel to be placed around the user's neck and shoulders. The lower portion of the towel will then lay flat in the desired manner.

The towel may also be used as a hair wrap. In that usage, the lower portion of the towel is lifted up and wrapped around the person's head and hair. This is used to hold the person's hair in place, and, if necessary to dry the hair. It is to be understood, however, that the use of the towel as a hair wrap is not meant as a limitation on the present invention.

In the preferred embodiment, the slit 30 is created by simply making a cut of an appropriate length into the towel material. The cut can be created using any well known manufacturing method. In making the slit, the preferred embodiment does not actually remove any material from the towel.

It has been found that this manufacturing method is the most efficient and least costly. It will be apparent to those skilled in the art that the slit can be modified from the structure of the preferred embodiment. For example, a V-shaped or U-shaped portion of the towel can be removed to give the desired effect.

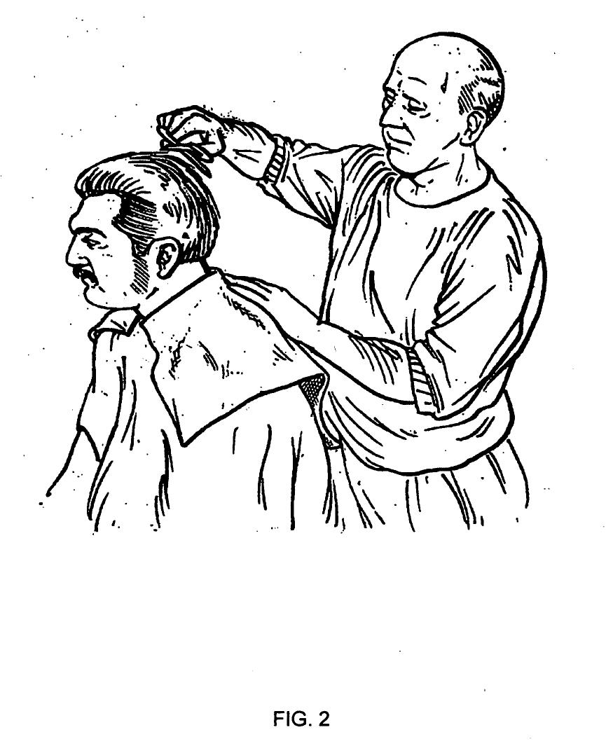

Referring next to FIG. 3, an alternative embodiment of the towel is illustrated. In this embodiment, a layer of plastic 40 is added to the towel 10. The plastic provides extra protection for the user. For example, the plastic will prevent water or chemicals from seeping through the towel. The plastic is affixed to the portion of the towel below the slit 30. When the towel is used, the portion of the towel with the plastic lays flat on the shoulders and back of the user.

The description of the present invention has been made with respect to specific arrangements and constructions of an improved towel. It will be apparent to those skilled in the art that the foregoing description is for illustrative purposes only, and that various changes and modifications can be made to the present invention without departing from the overall spirit and scope of the present invention. The full extent of the present invention is defined and limited only by the following claims.

What is claimed is:

1. In a towel having a least a top edge and first and second side edges, the improvement comprising:
a slit cut into said towel, said slit extending partially into said towel from of said side edges of said towel and being disposed substantially parallel to said top and bottom edges.

2. The towel of claim 1 further comprising reinforcement means located on the towel substantially adjacent the edges of said slit.

3. The towel of claim 1, wherein said towel includes at least a first and a second corner, and wherein attachment means are coupled to said first and second corners.

4. The towel of claim 3 wherein said first corner is defined by said top edge and said first edge and wherein said second corner is defined by said bottom edge and said second edge.

5. The towel of claim 3 wherein said attachment means comprise hook and loop material.

6. The towel of claim 3, wherein the towel is made of cotton material.

7. The towel of claim 3, wherein the towel is made of a synthetic fiber.

8. The towel of claim 3, wherein the towel is made of a cellulosic fiber such as paper.

9. In a towel having at least a top edge and first and second side edges, the improvement comprising:
a slit cut into said towel, said slit extending partially into said towel from one of said side edges of said towel and being disposed substantially parallel to said top and bottom edges;
the towel further comprising reinforcement means located on the towel including piping means stitched along the slit edges; and
attachment means coupled to a first and a second corner of the towel.

10. The towel of claim 9 wherein said towel is subdivided into an upper portion containing said slit and a lower portion, wherein a layer of plastic is attached to said lower portion of said towel.

11. The towel of claim 9 wherein said attachment means comprises hook and loop material.

12. The towel of claim 9, where the towel is manufactured from cotton.

13. The towel of claim 1, where the towel is manufactured from synthetic fiber.

14. The towel of claim 9, where the towel is manufactured from cellulosic fiber such as paper.
